(19) United States
(12) Patent Application Publication
(10) Pub. No.: US 2003/0218308 A1
(43) Pub. Date: Nov. 27, 2003

(54) Reconfigurable stock cart

(76) Inventor: Frederick W. Lamson, Birmingham, MI (US)

Correspondence Address: Thomas N. Young, Young & Basile, P.C., Suite 624, 3001 West Big Beaver Road, Troy, MI, 48084-3107, US

(21) Appl. No.: 10/154,088

(22) Filed: May 23, 2002

(51) Int. Cl. B62B 3/00

(52) U.S. Cl. 280/79.3

(57) ABSTRACT

The present invention relates to a stock cart having a base frame with interchangeable configurations and is especially useful in narrow aisles. A first configuration uses end frames attached to the base frame at either or both ends. A second interchangeable configuration for the cart supports at least one removable upper deck that can be connected between the first and second end frames. The removable deck has brackets connected to the ends thereof, for hanging the deck onto the cross-members of the first and second end frames. A third interchangeable configuration for the cart is designed to support a garment bar extending between and attached to each end frame for hanging clothes and the like while transporting the stock items.

### FIELD OF THE INVENTION

The present invention relates to a stock cart that can be configured in various ways and is particularly useful in areas having narrow traffic aisles.

### BACKGROUND OF THE INVENTION

Stock carts are used in stores and storage facilities to move stock, boxes, garments and other articles from place to place. They typically comprise a steel frame with wheels and vertical welded end structures which allow them to be pushed or pulled during use. The typical stock cart has one, fixed configuration and blunt corners which can damage persons and property on accidental contact.

### SUMMARY OF THE INVENTION

The present invention provides a reconfigurable stock cart having a base frame made up of parallel, laterally-spaced longitudinal frame members with smoothly upturned end portions to telescopically receive different types and lengths of vertical members. With these different vertical members and the end structures which are formed from them, the cart can be variously configured to provide upper and lower loading decks of different heights, as well as garment bars and the like.

In the preferred forms, the cart of the present invention has castered wheels at the four corners and provision for larger center wheels for load bearing capability as well as improved maneuverability.

In a first illustrated configuration, a ladder-shaped end frame having two laterally spaced, vertical members joined by a plurality of cross-member braces can be telescopically engaged to the upturned portions of the base frame members at either or both ends. The base frame is configured to provide a lower loading deck which can be a wire mesh grid, solid metal, or a plastic snap plate. An upper loading deck or a garment bar can be supported by and between the two end frames.

The removable upper deck can be a wire mesh or sheet metal. A plastic cover may be snapped over the wire grid to provide a smooth, seamless surface.

A lower profile configuration with shorter end frames and both upper and lower loading decks is disclosed.

The cart can be configured for narrow aisles with a length to width ratio of approximately 2.2 or more.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 shows a narrow aisle stock cart in a first configuration;

FIG. 2 shows an exploded view of the stock cart of FIG. 1;

FIG. 3 shows the stock cart in an alternative configuration;

FIG. 4 shows an exploded view of the stock cart of FIG. 3; and

FIG. 5 shows the stock cart with a garment bar.

### DESCRIPTION OF THE PREFERRED EMBODIMENT

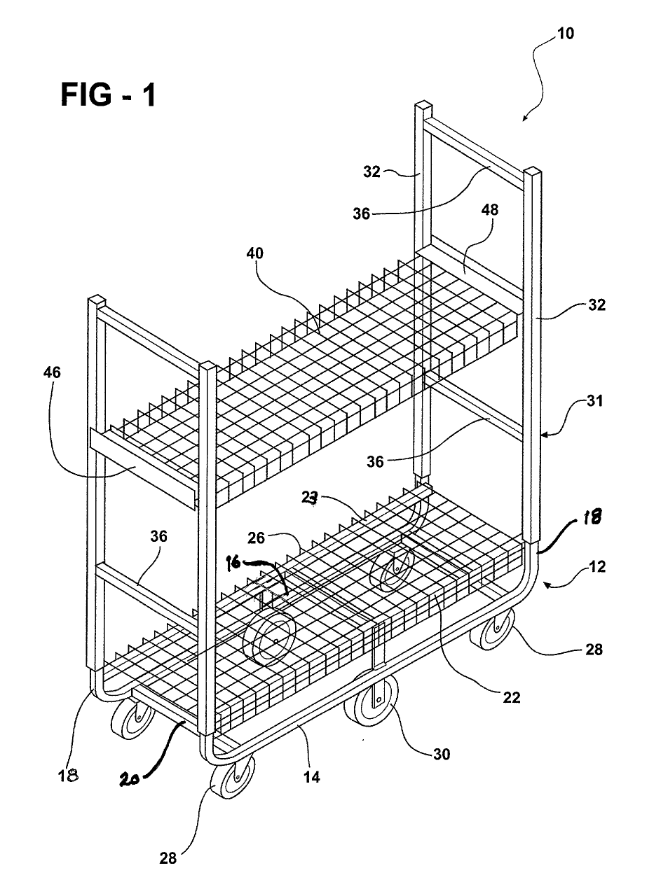

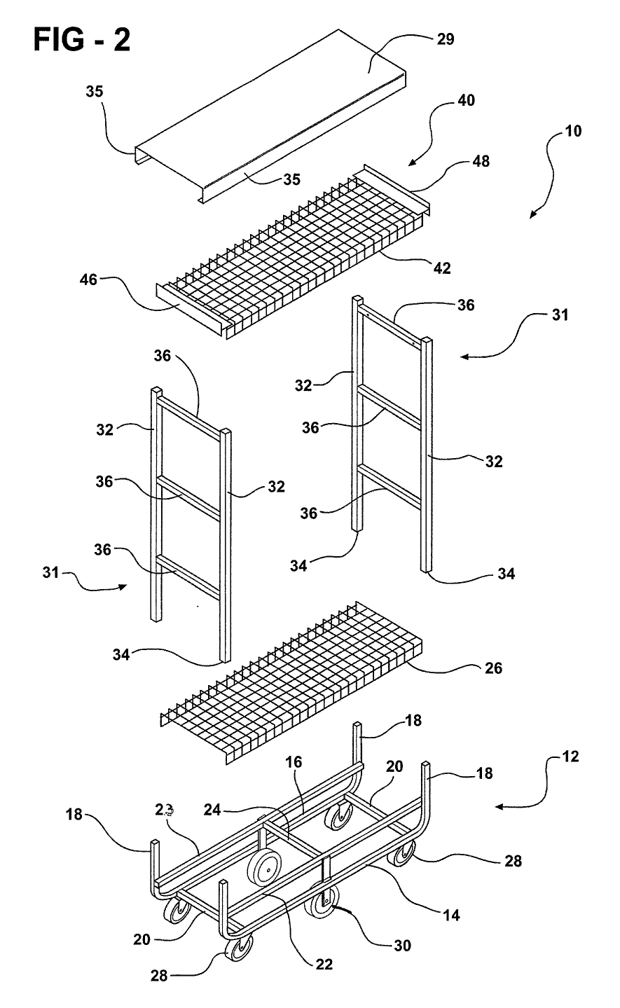

A first configuration for a stock cart is illustrated in FIGS. 1-2. The cart 10 has a base frame 12 made of two parallel, laterally spaced, tubular steel or aluminum members 14 and 16. Each member 14, 16 has smoothly upturned, vertical end portions 18 formed by a bending operation. Cross-braces 20 extend laterally between the members 14, 16 and are welded to them near the opposite longitudinal ends of the cart 10. Longitudinal braces 22 are welded to the upturned vertical end portion 18 and a mid-mounted cross-brace 24 is welded between them. A deck 26 of wire grid form may be placed on the longitudinal braces 22 and 23 as shown in FIG. 1.

Caster wheels 28 are secured to the base frame 12 at the four corners of the frame. Intermediate wheels 30, somewhat larger in diameter than the caster wheels 28, are removably secured to the center of the base frame 12 with a strap welded to the inside surface of member 14 and the outside surface of longitudinal brace 22 on one side of the base frame 12. A similar wheel support strap is welded between member 16 and longitudinal brace 23 on the other side of the base frame 12. In the preferred embodiment intermediate wheels 30 are positioned to the inside of members 14 and 16. When the two intermediate wheels 30 are utilized, the cart can be tipped and rolled on two caster wheels 28 and the two intermediate wheels 30 to enhance maneuverability of the cart 10. The deck 26, although shown as a wire grid, can also be made of solid metal or plastic.

End frames 31 are added to the longitudinally opposite ends of the base frame 12. Each end frame 31 comprises spaced, parallel, vertical tubular members 32 joined by welded cross-braces 36, one of which is located just below the top of each end frame. The tubular members 32 are slightly larger than the frame portions 18 such that the open bottom ends 34 can telescope over the portions 18 to attach the end frames 31 to the base frame 12. The cart 10 may be considered complete at this point. Alternatively, as upper deck 40 wire grid construction with end-connector structures 46 and 48 may be attached to and between any of the cross-braces 36 of the end frames 31. The structures 48 are configured to sit on the crossbars 36 with the grid edges 42 of deck 40 either turned down as shown or turned up to provide a retainer function. The structures 48 have a T-shaped cross section to provide this reversibility and are joined to the grid 40 by welding.

As shown in FIG. 2, a solid but flexible plastic deck 29 may be snapped over the wire grid deck 40 to carry items which may fall through a wire grid. The plastic deck 29 has resilient, wrap-around edge flanges 35 for this purpose.

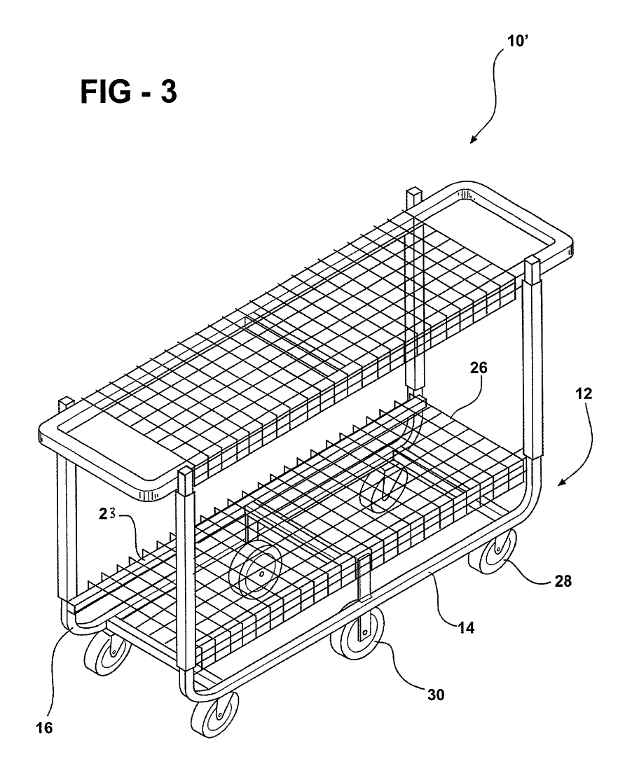

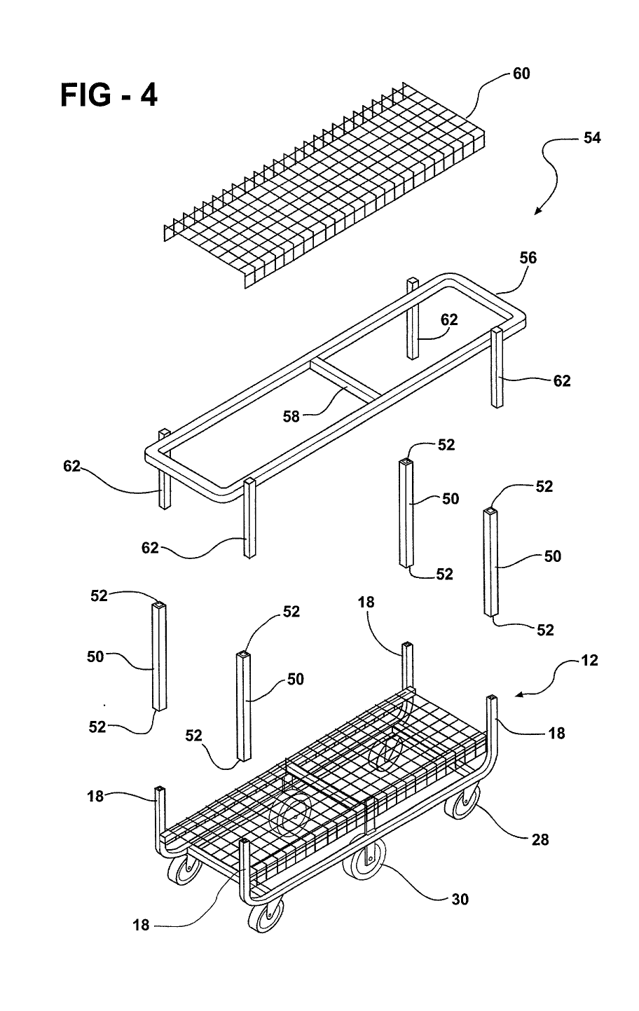

Now referring to FIGS. 3 and 4, cart 10′ having an alternative configuration will be described. Cart 10′ shares the base frame 12, wheels 28, 30 and lower deck 26 from the cart 10 of FIGS. 1 and 2. Intermediate tubular members 50 have apertures 52 at each end such that the intermediate tubular members 50 telescopically connect with the corresponding vertically extending legs 18 at one end and telescopically connect to upper deck arm extensions 62 at the other end. The intermediate tubular members 50 are larger in size than both the arms 62 and the vertically extending legs 18 such that the intermediate tubular members 50 can slide over each. The upper deck 54 is defined by a rectangular frame 56 with rounded corners and at least one cross-member 58 for providing a support for the deck surface 60 to attach thereon. The deck surface can be a wire mesh grid 60 as shown in FIG. 4 or, alternatively, can be made of solid metal or plastic. The upper deck 54 has four arms 62 that telescopically slide into the intermediate tubular members 50. The upper deck will slide down into the intermediate tubular members 50 until the ends 52 engage the rectangular frame 56.

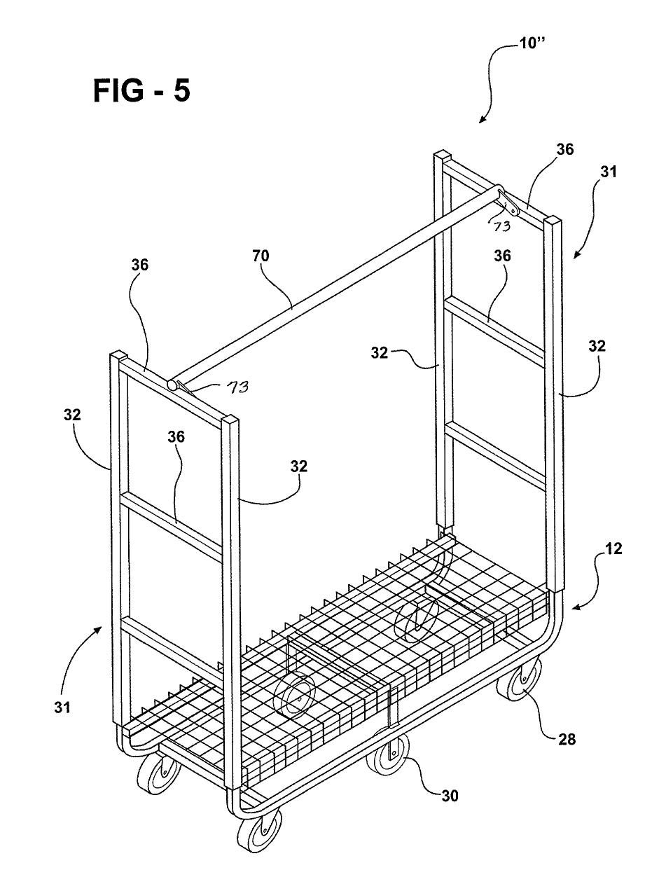

Now referring to FIG. 5, a third configuration is shown with a garment bar 70 connected between the end frames 31 for transporting clothes and the like while transporting items to and from a stock location. The cart 10″ shares the base frame 12, wheels 28, 30, lower deck 26, and two end frames 31 with cart 10 as shown in FIGS. 1 and 2. The garment bar 70 is attached to the cross-members 36 on the end frames 31 or, alternatively, can be attached to an upright post 32 on each of the end frames 31. The garment bar 70 extends in a direction parallel with respect to the longitudinal axis of the cart 10″. The bar 70 is mounted on pivotal arms 73 so it can be flipped to one side when not in use.

All of the configurations described above are preferably constructed from square tube stock which is easily welded, painted, powder coated and/or chrome plated as necessary. Round or oval stock can be used but square stock is preferred for drilling holes and attaching wheel flanges and the like. Typical, but not limiting dimensions for the cart 10 in FIGS. 1 and 2 are about 40 inches in length by 18 inches in width for a length to width ratio of about 2.2. The cart 10′ of FIGS. 3 and 4 may be 60 inches by 18 inches for a length to width ratio of 3.3. The length can be expanded up to 75 inches or more with a length to width ratio of 4 or more. The narrow width makes it easy to pass down narrow aisles and the smooth, rounded corners reduce the likelihood of damage to persons and/or property.

What is claimed is:

1. A stock cart comprising:
a base frame made up of first and second parallel, spaced apart tubular members, each member having a horizontally extending elongated rail portion terminating in smoothly upturned vertically extending leg portions;
at least one cross-brace extending transversely between the first and second base frame members;
at least one longitudinal brace extending longitudinally between the upturned vertically extending leg portions of each elongated tubular member;
caster wheels connected to the base frame essentially at the corners thereof to allow rolling movement of the frame;
at least one end frame attached to the base frame; and
the end frame having parallel, spaced apart tubular vertical posts telescopically attachable to the upturned end portions of one end of the base frame.

2. The stock cart of claim 1 further comprising:
at least one cross member extending transversely between the longitudinal braces of the first and second tubular members; and
a deck connectable to the base frame and extending between the braces of the first and second tubular members.

3. The stock cart of claim 2 further comprising:
the deck having a support surface with side edges bent with respect to the support surface.

4. The stock cart of claim 2, wherein the deck further comprises a wire mesh grid.

5. The stock cart of claim 4 further comprising:
a solid cover operably engageable with the wire mesh grid connected to the deck.

6. The stock cart of claim 1 further comprising:
a solid cover connectable to the base frame and extending between the braces of the first and second tubular members.

7. The stock cart of claim 1, wherein the end frame further comprises:
first and second vertically extending elongated posts spaced transversely from one another, each post having an aperture at one end with a complementary cross section to matingly receive at least a portion of one of the vertically extending legs of the base frame to be telescopically sheathed therein, and at least one cross member extending between the first and second posts.

8. The stock cart of claim 7 further comprising:
a stop defined by the longitudinal brace on the base frame brace limiting a depth of insertion of the vertically extending leg within the aperture of the post.

9. The stock cart of claim 7, further comprising:
first and second end frames, each end frame having first and second vertically extending elongated posts spaced transversely from one another, each post having an aperture at one end with a complementary cross section to matingly receive at least a portion of one of the vertically extending legs to be telescopically sheathed therein, and at least one cross member extending between the first and second posts; and
at least one removable deck connectable between cross members of the first and second end frames, each removable deck having a support surface with first and second side edges, first and second ends, and brackets connected along each end for hanging the removable deck from the cross members of the first and second end frames when the end frames are connected to opposite ends of the frame.

10. The stock cart of claim 9, wherein the side edges of the removable deck are angularly bent with respect to the support surface.

11. The stock cart of claim 10, wherein the brackets are reversible allowing the removable deck to be flipped upside-down and connected between the cross members creating a receptacle with upwardly extending side edges.

12. The stock cart of claim 9 further comprising:
a solid cover connectable to the removable deck and extending between the cross members of the first and second end frames.

13. The stock cart of claim 9 further comprising:
a garment bar having first and second ends, each end having a connector for connecting to one of the first and second end frames.

14. A stock cart comprising:
a base frame made up of first and second parallel, spaced apart tubular members, each member having a horizontally extending elongated rail portion terminating in smoothly upturned vertically extending leg portions;
at least one cross-brace extending transversely between the first and second base frame members;
at least one longitudinal brace extending longitudinally between the upturned vertically extending leg portions of each elongated tubular member;
caster wheels connected to the base frame essentially at the corners thereof to allow rolling movement of the frame;
a plurality of intermediate tubular members having apertures at each end thereof, each tubular member telescopically connected at one end with a corresponding vertically extending leg portion of the tubular members of the base frame; and
at least one additional deck having a rectangular frame with rounded corners, the rectangular frame having long side and short side members, at least one cross member extending transversely between the at least one of the parallel long and short side members, each longitudinal end of the rectangular frame defining tubular handles, and a plurality of arm extensions connected to the rectangular frame for telescopically interconnecting with an end of the intermediate tubular members opposite from the base frame.

15. The stock cart of claim 14 further comprising:
the additional deck having a support surface with side edges bent with respect to the support surface for cooperatively engaging the rectangular frame.

16. The stock cart of claim 15, wherein the support surface further comprises a wire mesh grid.

17. The stock cart of claim 16 further comprising:
a solid cover operably engageable with the wire mesh grid.

18. The stock cart of claim 17, wherein the solid cover is made of deformable plastic for moving with respect to the wire mesh surface between a locked position and released position.

19. The stock cart of claim 1 further comprising at least two intermediate wheels attached along the rail portion of each tubular member.

20. The stock cart of claim 19, wherein the intermediate wheels are larger than the caster wheels for allowing the cart to tip and roll on two caster wheels and two intermediate wheels enhancing maneuverability of the cart.

21. The stock cart of claim 1, wherein a length-to-width ratio of the frame is at least approximately 2.2.
